(19) United States
(12) Patent Application Publication
(10) Pub. No.: US 2025/0310215 A1
(43) Pub. Date: Oct. 2, 2025

(54) APPLICATION FUNCTION INFLUENCED NETWORK AND QUALITY OF EXPERIENCE PROVISIONING

(71) Applicant: Apple Inc., Cupertino, CA (US)

(72) Inventors: Arnab Roy, San Diego, CA (US); Ahmed M. Soliman, Munich (DE); Ayman F. Naguib, Cupertino, CA (US); Norman Goris, Dortmund (DE); Oner Orhan, San Jose, CA (US); Onur Sahin, Highland, CA (US); Sudeep Manithara Vamanan, Nuremberg (DE)

(73) Assignee: Apple Inc., Cupertino, CA (US)

(21) Appl. No.: 19/066,607

(22) Filed: Feb. 28, 2025

Related U.S. Application Data
(60) Provisional application No. 63/571,989, filed on Mar. 29, 2024.

(51) Int. Cl. H04L 41/16; H04L 41/5067

(52) U.S. Cl. CPC H04L 41/16; H04L 41/5067

(57) ABSTRACT

Techniques are described herein for paging adaption. An example, method includes receiving, from a user equipment (UE), a request for configuration optimization information for an application. The method can further include causing a first machine learning model at an application function (AF) to generate first intermediate results based at least in part on the request and collaborative analytics information from the UE. The method can further include accessing second intermediate results generated using a second machine learning model at a network data and analytics function (NWDAF). The method can further include causing a third machine learning model at the AF to predict a quality of experience (QoE) label metric associated with the application based at least in part on the first intermediate results and the second intermediate result.

### CROSS-REFERENCES TO RELATED APPLICATIONS

This application claims the benefit of U.S. Provisional Application No. 63/571,989, filed on Mar. 29, 2024, which is incorporated by reference.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of an example system for training models for multi-domain assisted QoE provisioning, according to one or more embodiments.

FIG. 2 is an illustration of an example system for multi-domain assisted QoE provisioning, according to one or more embodiments.

FIG. 3 is an example signaling diagram for multi-domain assisted QoE provisioning, according to one or more embodiments.

FIG. 4 is an example signaling diagram for multi-domain assisted QoE provisioning, according to one or more embodiments.

FIG. 5 is an example signaling diagram for multi-domain assisted QoE provisioning, according to one or more embodiments.

FIG. 6 is an example signaling diagram for multi-domain assisted QoE provisioning, according to one or more embodiments.

FIG. 7 is an example signaling diagram for multi-domain assisted network provisioning, according to one or more embodiments.

FIG. 8 is an example signaling diagram for multi-domain assisted network provisioning, according to one or more embodiments.

FIG. 9 is an illustration of an example system for multi-domain assisted QoE provisioning, according to one or more embodiments.

FIG. 10 is an illustration of an example system for multi-domain assisted QoE provisioning, according to one or more embodiments.

FIG. 11 is an illustration of an example system for multi-domain assisted QoE provisioning, according to one or more embodiments.

FIG. 12 is an example process flow for multi-domain assisted QoE provisioning, according to one or more embodiments.

FIG. 13 is an example process flow for multi-domain assisted QoE provisioning, according to one or more embodiments.

FIG. 14 is an example process flow for multi-domain assisted QoE provisioning, according to one or more embodiments.

FIG. 15 is an illustration of an example of receive components, in accordance with some embodiments.

FIG. 16 is an illustration of an example of a user equipment (UE), in accordance with some embodiments.

FIG. 17 is an illustration of an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

A network can collect information across a network to determine the quality of experience (QoE) of an application or service executing on a user equipment (UE). The network can use the information to quantify the acceptability of the application or service to a user. For example, the network can collect information such as network information (e.g., network slice status, applied policy), UE information (e.g., UE power, UE trajectory), and application layer information (e.g., applied codec, QoE metrics). The network can include various functions to assist in collecting information. For example, a network data and analytics function (NWDAF) can collect data from core network (CN) functions to perform network analytics, and provide information to authorized data consumers. The NWDAF can provide network analytics to a consumer (e.g., a network function (NF), an application function (AF), an external user, or other appropriate consumer). Conventionally, the NWDAF can collect performance information from the radio access network (RAN) using the operation and management (OAM) function of the network. However, conventionally, the NWDAF does not collect the performance information in real time. Conventionally, the NWDAF is configured to collect performance information from a specific UE, an OAM minimization of drive test (MDT) can be used. However, the MDT can be inconvenient in a live network and especially if the specific UE is part of a large group of UEs. There are some release 19 enhancement proposals (e.g., system aspects 2 (SA2) #157 S2-2306503, China Mobile, Vivo). One proposal is for the NWDAF to collect UE radio link condition information in real-time. Another proposal is to enhance the network analytics with the real-time information from the UE radio link. However, due to privacy concerns, the UE's application information may not be available. Furthermore, due to dynamically changing channel conditions, frequent reporting is required, which can result in a large RAN signaling overhead.

A data collection application function (DCAF) can be responsible for collecting UE data for specific applications and reporting the information to the NWDAF. Currently, the DCAF can be responsible for collecting information, reporting information, and exposure from UE applications that support the NWDAF. The DCAF can be deployed inside or outside a trusted domain. The DCAF can be in communication with a UE and an application service provider. The DCAF can receive data reports (e.g., reporting format conversion, normalization, reporting domain-specific anonymization of information, disaggregation of information into reports to be exposed as events). Furthermore, the DCAF can be responsible for exposing processed UE information to event notification subscribers inside the trusted domain (e.g., NWDAF) and outside the trusted domain (e.g., event consumer AF in the application service provider).

Cross-domain information sharing can be problematic due to privacy concerns and commercial concerns. For example, a UE may be configured to not provide certain information due to privacy concerns. In another instance, a CN can be configured to not share particular information with a UE due to commercial reasons. Therefore, one issue can be how to use technology to collect information from different segments (e.g., UE, AF, and NWDAF), such that the different segments do not have to share information. Furthermore, another issue can be how to use application specific information that is available at the AF to more accurately provision network resources to improve the QoE. Embodiments described herein address the above-referenced issues by using a vertical federated learning (VFL) techniques, in which a UE, an, AF, and an NWDAF can use VFL techniques to locally gather information and process the information on a local bottom machine learning model. The separate bottom machine learning models can generate predictions that can be processed by a top machine learning model that can predict a QoE metric for a desired label (e.g., battery consumption, load time, network performance, or other QoE label).

Federated learning can include techniques for multiple participants to collaborate to train a model without having to share raw data, where the raw data can include data that has not been processed by a machine learning model. vertical federated learning (VFL) and horizontal federated learning (HFL). In a VFL model, each participant can possess information in the same sample space, but in different attribute spaces. Furthermore, each VFL participant can possess part of a full machine learning model (e.g., VFL model), and each participant can locally train their part of the full machine learning model. Therefore, information that is exchanged between participants can be intermediate results (e.g., learning representations) generated by bottom models and using local information and the model gradients, rather than unprocessed local information. The intermediate results can be based on the particular task of the machine learning model. If the machine learning model is tasked with regression, the intermediate results can be numerical values that represents a predicted outcome. In another example, if the task is anomaly detection, the intermediate results can be a binary classification indicating whether or not an input is anomalous. It should be appreciated that other machine learning models can be used to perform other tasks that may be used for optimizing a QoE. Furthermore, different machine learning models can perform different tasks using different local information. Therefore, each machine learning model for each VFL participant has flexibility and can process local information without having to share the local information with another participant.

A VFL model can include a hierarchical structure in which bottom models can generate intermediate results and provide the intermediate results to a top model. Each participant can train a local model using local information. For VFL, each participant may be gathering information from the same set of customers (e.g., a set of UEs). However, each participant may be operating under a different business model. The localized training can include updating the bottom model's parameters to minimize a loss function. The updated bottom model parameters can be transmitted to a top model. The top model can use an aggregation technique (e.g., averaging, weighted averaging) to process the updated parameters from the bottom models. An aggregated global model can then be distributed from the top model to the bottom models. The bottom models can update their respective parameters based on the aggregated global model. This process can be repeated until the VFL model can perform to a desired accuracy.

The following is a set of example steps that can be performed to train a model using a VFL technique. In a first step, the participants can engage in a private set intersection, in which the participants can determine the intersection of their respective local information without sharing the information. For example, the participants can determine information that intersects based on common identifiers (e.g., UE identifiers) or common time stamps for time dependent features. At a second step, each participant can use a local model (e.g., bottom model) to process information that is stored locally. At a third step, each participant can transmit third model parameters (e.g., an intermediate results can include internal variables, coefficients, weights, or other parameters that assist in defining a relationship between an input and an output label) to a label owner (e.g., the entity managing the top model). At a fourth step, the label owner can use the outputs from the bottom models to determine a loss function value based on the top model and desired output label. At a fifth step, the label owner can determine a value based on the loss function and use backpropagation to determine an updated gradient for the top model and updated parameters for the top model. It should be appreciated that in some instances, the top model may not be trainable (e.g., an aggregation model or a tree model), then the label owner may not determine updated parameters and gradients for the top model. At a sixth step, the updated parameters and gradient for the top model can be transmitted to each participant. At a seventh step, each participant can use the top model gradient to determine a gradient for a local bottom model, and update the bottom model parameters based on the updated gradient. Each bottom model can then process the local information using their respective updated parameters.

The following is another set of example steps that can be performed to train a model using a VFL technique. In some instances, a label owner may not have identified local features that are to be inputted into a local machine learning model. This can include an instance in which the model is optimized at the UE and the label owner is responsible for scoring the QoE, but cannot share the label with the CN or AF. In a first step, the participants can engage in a private set intersection, in which the participants can determine the intersection of their respective local information without sharing the information. At a second step, each participant can use a local model to process information that is stored locally. At a third step, each participant can transmit third model parameters to a label owner. At a fourth step, the label owner can use the outputs from the bottom models to determine a loss function value based on the top model and desired output label. At a fifth step, the label owner can determine a value based on the loss function and use backpropagation to determine updated gradients and updated parameters for each bottom model. At a sixth step, the updated parameters and gradient for the top model can be transmitted to each participant. At a seventh step, each participant can use the top model gradient to determine a gradient for a local bottom model, and update the bottom model parameters based on the updated gradient. Each bottom model can then process the local information using their respective updated parameters.

HFL can be a federated learning technique that can be performed using participants that locally store information with the same attribute space and different sample spaces. In HFL, each participant can locally store information and a local machine learning model. Each participant can periodically receive parameters from a global model. Furthermore, in HFL, the structure of each participant's machine learning model can be fixed and consistent.

In one embodiment, a VFL model can include sub-models (e.g., bottom models and a top model) at the AF and the CN. Each sub-model can operate on local information available at the respective domain (e.g., AF, CN). The VFL model can be used to generate an output that can influence the AF and an application executing on the UE to enhance the QoE for the application. The local sub-model at the AF can receive an input, an application configuration, UE context information, or other appropriate information. The local sub-model at the CN (e.g., NWDAF) can receive as input network congestion information, slice availability information, and other appropriate information. The output of the VFL model can be an application re-configuration profile that optimizes the QoE based on predicted user and network conditions. In this embodiment, the sub-models can be supplied by the AF. Alternatively, the sub-models can also be supplied by the NWDAF. In this instance, a final output of a model at the NWDAF can be transmitted to the AF. In yet another alternative, each of the AF and the NWDAF can include their own sub-models, and either the AF or the NWDAF can include a model that is responsible for generating a final output. The final output can be used to adjust an application configuration as a user is interacting with the application.

In another embodiment, a VFL model can include sub-models (e.g., bottom models and a top model) at the AF and the CN. Each sub-model can operate on local information available at the respective domain (e.g., AF, CN). The VFL model can be used to generate customized analytics to pre-provision the network to support future QoE requirements for a user. The local sub-model at the CN can receive as input network congestion information, slice availability information, and other appropriate information. The output can be, for example, future slice re-configuration, or other customized analytics. In this embodiment, the sub-models can be supplied by the NWDAF, and a final output can be transmitted from the NWDAF to a consumer network function (NF). Alternatively, the sub-models can be supplied by the AF and a final output can be transmitted from the NWDAF to the consumer NF. In yet another alternative, the each of the AF and the NWDAF can include their own sub-models, and NWDAF can include a model that is responsible for generating a final output that is transferred to a consumer NF. The final output can be used to adjust an application configuration before a user interacts with the application.

In another embodiment, the UE can participate in the VFL technique and include one of the bottom models. In some instances, each of the AF, the NWDAF, and the UE can include a bottom model of the VFL model. In another instance, each of the AF, the NWDAF can include a bottom model, and the UE can include a top model of the VFL model. The AF can further include a top model of the VFL model that can generate customized analytics to influence the AF and application on the UE to optimize the QoE.

In another embodiment, a VFL model can include sub-models (e.g., bottom models and a top model) at the AF and the CN, where each include models that use local data to generate a respective output. The UE can participate in the VFL as a label owner, such as by scoring the QoE for an application. In this instance, the UE may not include a sub-model of the VFL model. The QoE scores can be stored as private information and the UE can optimize an application preference or setting based on the QoE prediction. The inputs for the sub-model at the AF can include application configuration information, UE context information, or other appropriate information. The inputs for the sub-model at the NWDAF can include network congestion information, slice availability information and other appropriate information. The output of the VFL model can be a future application reconfiguration request or other appropriate output. In this embodiment, the UE may only include labels (e.g., perceived video quality in an extended reality (XR) session during a training phase.

The herein-described embodiments provided several technical advantages. For example, by processing local data using a local machine learning model, there may be no exposure of raw data between a UE, a CN, and an AF. The localized machine learning models at the UE, the CN, and the AF can quickly access the locally stored data at the CN and the AF. The localized machine learning model processing can permit an operator and a vendor to agree on a system configuration procedures that optimize the network's operations.

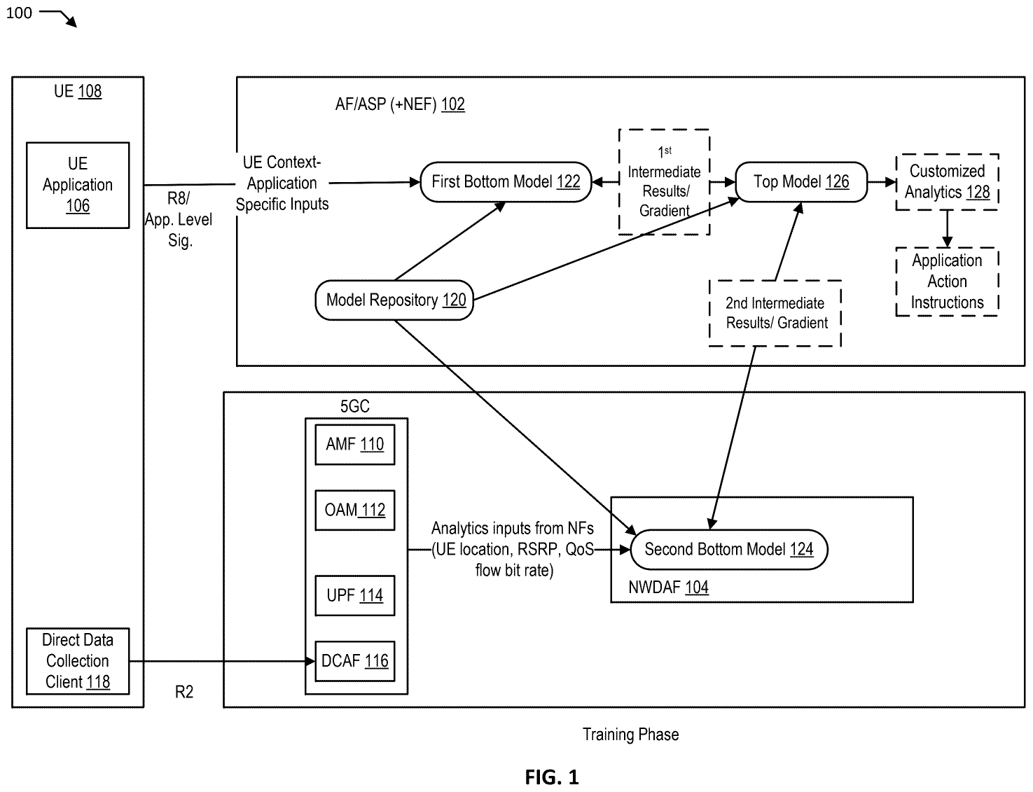

FIG. 1 is an illustration 100 of an example system for training models for multi-domain assisted QoE provisioning, according to one or more embodiments. As illustrated, a VFL model can include a sub-models that the AF 102 and the NWDAF 104. The VFL model can be trained to generate customized QoE analytics to influence the AF 102 and a UE application 106 at the UE 108. The AF 102 can perform QoE provisioning based on the custom analytics.

The AF 102 can access UE context information (e.g., mobility information, location information, and other appropriate context information) and application specific inputs (e.g., current data rate, requested data rate, available buffer capacity, available processor capacity, and other appropriate application specific inputs) from the UE 108. The NWDAF 104 can access information (per-UE information, per-UE group information, per slice per NF information from various NFs (e.g., access and mobility function (AMF) 110, OAM 112, user plane function (UPF) 114, and DCAF 116). For example, the DCAF 116 can access UE information from a direct data collection client 118 at the UE 108.

The AF 102 can include a model repository 120 that can be used by the AF 102 to select a first bottom model 122 for the AF 102, a second bottom model 124 for the NWDAF 104, and a top model for the AF 102. The first bottom model 122, the second bottom model 124, and the top model 126 can be sub-models that collectively form the VFL model. The AF 102 can select the first bottom model 122, the second bottom model 124, and the top model 126 based on the parameters of the UE application 106. The AF 102 can use the intermediate results of the first bottom model 122 and the second bottom model 124 to train the top model 126. The AF can cause the first bottom model 122 to process the UE context information and the application specific inputs to generate first intermediate results. The NWDAF 104 can cause the second bottom model 124 to process the analytics inputs to generate second intermediate results. The AF 102 can transmit the first intermediate results from the first bottom model 122 to the top model 126. The NWDAF 104 can share the second intermediate results with the AF 102. The AF 102 can then transmit the second intermediate results to the top model 126.

The top model 126 can use the first intermediate results and the second intermediate results to determine a loss function value based on the top model and desired label. For example, the top model can use the first intermediate results and the second intermediate results to generate a final output (e.g., customized analytics associated with a label). The final output can be compared to ground truth information to generate a loss function value. For example, the final output can be a numerical representation that relates to the label (e.g., perceived video quality on a video sharing application). The final output can be compared to a ground truth numerical representation for perceived video quality on a video sharing application. The loss function can be used to perform a backpropagation to determine updated gradients for the model parameters at the top model 126. The AF 102 can update the parameters of the top model 126 based on the updated gradient for the top model 126. The AF 102 can further determine an updated gradient for the first bottom model 122 based on the updated gradient for the top model 126. The AF 102 can further update the parameters for the first bottom model 122 based on the updated gradient. The AF 102 can transmit the updated gradient for the top model 126 to the NWDAF 104. The NWDAF 104 can further determine an updated gradient for the second bottom model 124 based on the updated gradient for the top model 126. The NWDAF 104 can further update the parameters for the second bottom model 124 based on the updated gradient. This process can repeat itself until the VFL model can generate outputs to a threshold accuracy.

As illustrated, the model repository 120 is located at the AF 102 and the AF 102 provides the second bottom model 124 to the NWDAF 104. For example, based on the label of the final output from the top model 126, the information to be processed, or other appropriate consideration, the AF 102 can select a first bottom model 122, a second bottom model 124, and a top model 126. In another embodiment, including each other embodiment described herein, the model repository 120 can be located at the NWDAF 104, and the NWDAF 104 provides the first bottom model 122 to the AF 102. Furthermore, the top model 126 can be at the NWDAF 104, and the NWDAF 104 can provide the output of the top model 126 to the AF 102. The AF 102 can then make one or more adjustments to the UE application 106 to optimize the QoE based on the output from the top model 126. The AF 102 can make the adjustment as a user is interfacing with the UE application 106. As illustrated, the first bottom model 122 and the top model 126 can be trained without the AF 102 sharing UE context information and application specific inputs with the NWDAF 104, or receiving analytics inputs from the NWDAF 104. Furthermore, the second bottom model 124 can be trained without sharing analytics inputs with the AF 102 or receiving UE context information and application specific inputs from the AF 102.

In another embodiment, each of the AF 102 and the NWDAF 104 can include a respective model repository. Therefore, each of the AF 102 and the NWDAF 104 can provide their own model. In this embodiment, the top model 126 can be in either the AF 102 or the NWDAF 104.

The machine learning models (e.g., first bottom model 122, second bottom model 124, and top model 126) can be architecture agnostic. The models can, for example, be convolutional neural networks (CNNs) or recurrent neural networks (RNNs). In some embodiments, a model architecture can be selected based on a label of a final output of the top model 126.

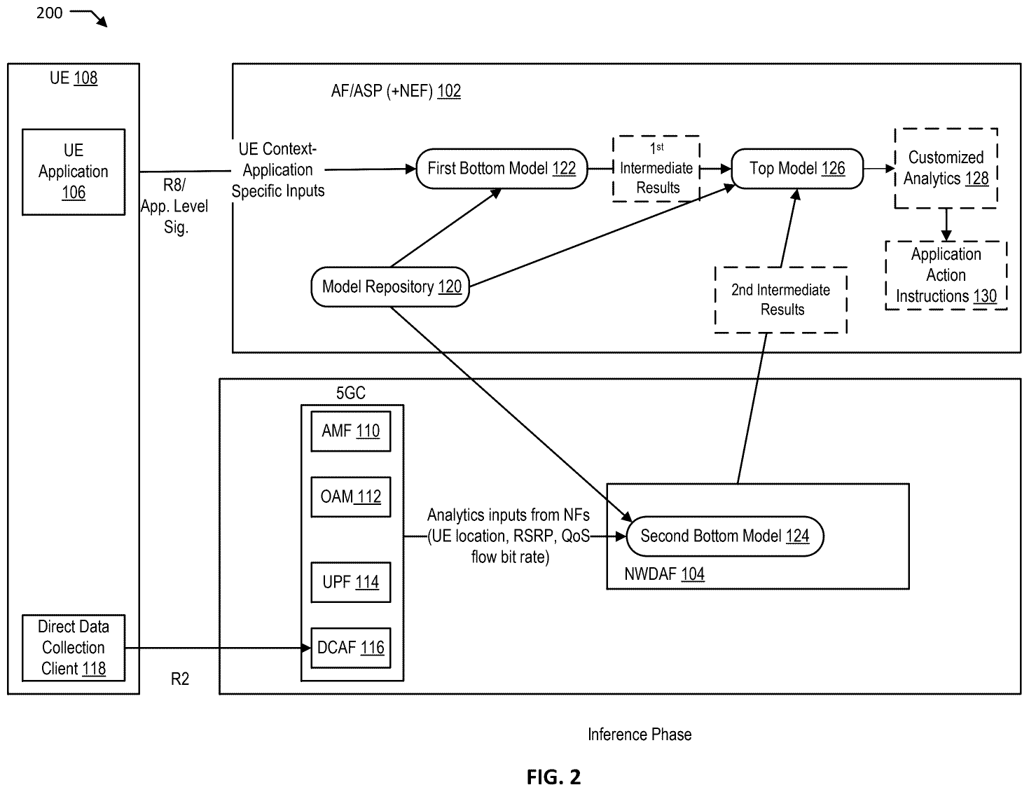

FIG. 2 is an illustration 200 of an example system for multi-domain assisted QoE provisioning, according to one or more embodiments. FIG. 2 shows a system that is similar to the system illustrated in FIG. 1, and used for an inference phase rather than a training phase. The first bottom model 122 can receive UE context information and application specific inputs (e.g., UE position information, application metrics, experienced data rates and expected data rates) from the UE 108 and generate first intermediate results that is transmitted to the top model 126. The second bottom model 124 can receive analytics inputs from various NFs and generate second intermediate results. For example, the OAM can provide reference signal received power (RSRP) information, a mean number of UEs registered in a network slice, a mean number of established packet data units (PDUs), resource utilization information of a network slice instance, or other appropriate information. Various NFs can also provide information. For example, the AMF can provide reports of the total number of UEs served by the AMF per Single-Network Slice Selection Assistance Information (S-NSSAI). The network repository function (NRF) can also provide resource utilization information of a network slice instance. The NWDAF 104 can transmit the second intermediate results to the AF 102, which can provide the second intermediate results to the top model 126. The top model 126 can output customized analytics 128 that can be used by the AF 102 to generate application action instructions 130. The application action instructions 130 can be used to reconfigure the UE application 106. In the inference phase, the top model 126 does not pass gradients back to the first bottom model 122 and the second bottom model 124 as the gradients and parameters are not updated during the inference phase.

As illustrated, the model repository 120 is located at the AF 102. In another embodiment, the model repository 120 can be located at the NWDAF 104, and the NWDAF 104 provides the first bottom model 122 to the AF 102. Furthermore, the top model 126 can be at the NWDAF 104, and the NWDAF 104 can provide the output of the top model 126 to the AF 102. The AF 102 can then make one or more adjustments to the UE application 106 to optimize the QoE based on the output from the top model 126. In another embodiment, each of the AF 102 and the NWDAF 104 can include a respective model repository. Therefore, each of the AF 102 and the NWDAF 104 can provide their own model. In this embodiment, the top model 126 can be in either the AF 102 or the NWDAF 104.

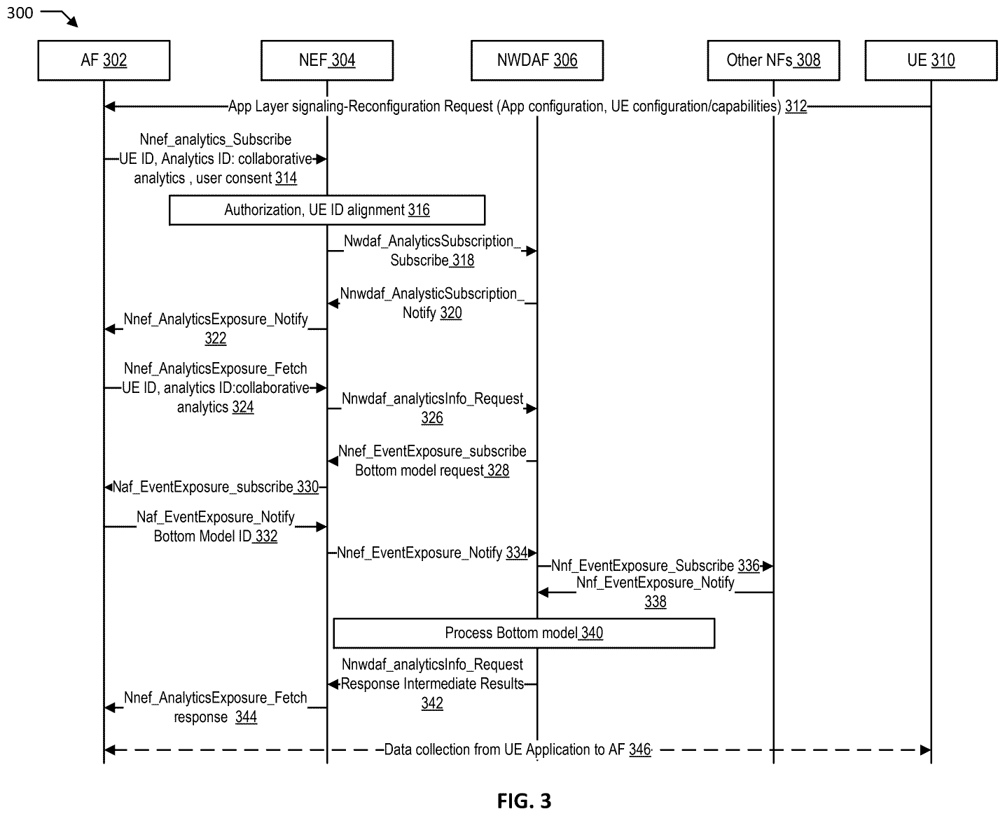

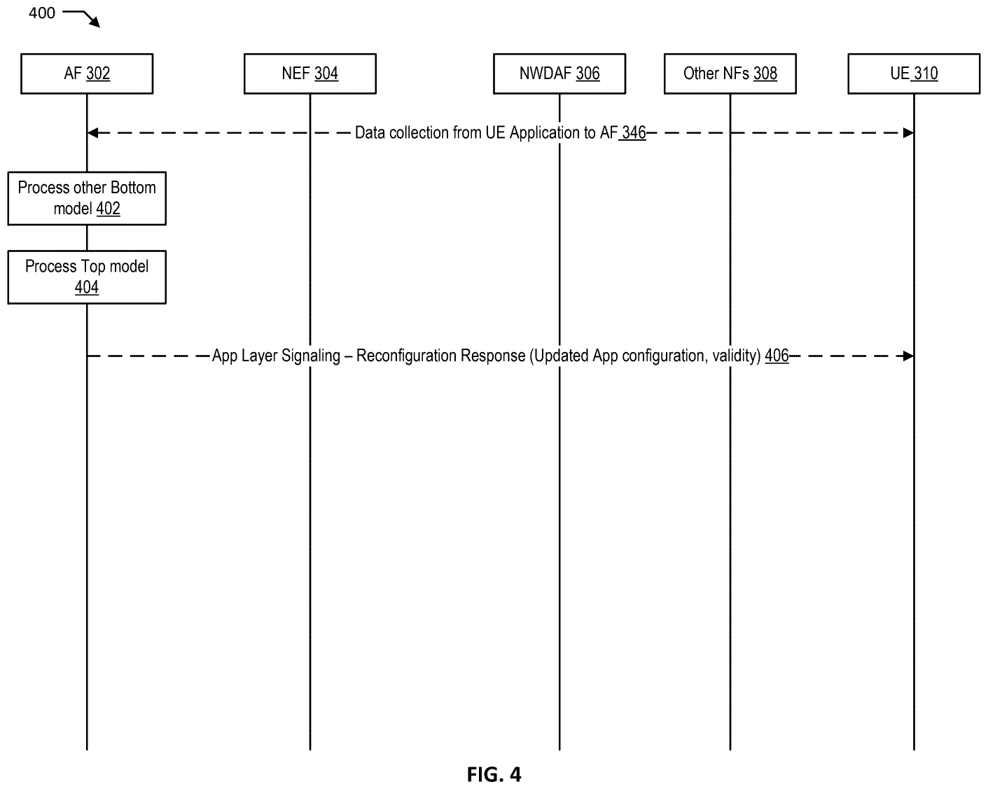

FIGS. 3 and 4 are collectively a signaling diagram for multi-domain assisted QoE provisioning, according to one or more embodiments. FIG. 4 is a continuation of FIG. 3. FIG. 3 is an example signaling diagram 300 for multi-domain assisted QoE provisioning, according to one or more embodiments. As illustrated, an AF 302 is in communication with a network exposure function (NEF) 304, and NWDAF 306, other NFs 308, and a UE 310.

At 312, a machine learning client at the UE 310 can transmit a reconfiguration request (e.g., application reconfiguration, UE capability reconfiguration) via application layer signaling to the AF 302. This request can trigger a dynamic application configuration optimization by the AF 302. At 314, the AF 302 can request to subscribe to analytics information via the NEF 304. The request can include an analytics identifier that is associated with a request for collaborative analytics. The request can further include an indication of user consent for the collaborative analytics. At 316, the NEF 304 can determine whether the AF 302 is authorized for the analytics information subscription. The NEF 304 can be assisted by the unified data management (UDM) function to align the UE's external (e.g., international mobile subscriber identity (IMSI), Generic Public Subscription Identifier (GPSI)) and internal (e.g., subscription permanent identifier (SUPI), 5G globally unique temporary identity (GUTI)) identifiers. It should be appreciated that additional alignment across different samples may be needed with respect to time (e.g., to remove stale samples). Furthermore, additional NFs may be required to perform this additional alignment. If the AF 302 is authorized, for the analytics information subscription, then the NEF 304 subscribes to the analytics information from the NWDAF 306 at 318. If, however, the AF 302 is not authorized, then the NEF 304 does not subscribe to the information.

At 320, the NWDAF 306 transmits the notification to the NEF 304 that the subscription is accepted for the analytics information to the NEF 304. At 322, the NEF 304 transmits a notification to the AF 302 that the subscription to the analytics information has been accepted. At 324, the AF 302 transmits a request to the NEF 304 to fetch the analytics information from the NWDAF 306. The request can include the UE identifier and analytics identifiers. The request can also indicate that the analytics information is to be use for collaborative analytics. At 326, the NEF 304 can transmit a request to the NWDAF 306 to indicate that the request is for analytics information associated with the collaborative analytics.

At 328, the NWDAF 306 can transmit a request for a bottom model from the AF 302 via the NEF 304. At 330, the NEF 304 transmits the request for the bottom model to the AF 302. At 332, the AF 302 transmits a response to the NEF 304. The response can include either the bottom model, a bottom model ID, or a set of layers of the overall VFL model. If the AF 302 provides a bottom model ID, the NWDAF 306 can be expected to access the model from a model repository using the bottom model ID. At 334, the NEF 304 can transmit the response from the AF 302 to the NWDAF 306. At 336, the NWDAF 306 can transmit a request to the other NFs 308 for information to be used to generate intermediate results. At 338, the other NFs can transmit information (e.g., RSRP information, a mean number of UEs registered in a network slice, a mean number of established PDUs, resource utilization information of a network slice instance, reports of the total number of UEs served by the AMF per S-NSSAI, resource utilization information of a network slice instance) to be used to generate intermediate results.

At 340, the NWDAF 306 can use the bottom model at the NWDAF 306 to process the information to generate the intermediate results. By generating the intermediate results at the NWDAF 306, the AF 302 does not receive the RSRP information, the mean number of UEs registered in a network slice, the mean number of established PDUs, the resource utilization information of a network slice instance, the reports of the total number of UEs served by the AMF per S-NSSAI, and the resource utilization information of a network slice instance. Rather the intermediate results can include features and relationships between features that have been extracted from this information. At 342, the NWDAF 306 can transmit the intermediate results to the NEF 304. At 344, the NEF 304 can transmit a response, including the intermediate results, to the AF 302. At 346, the application at the UE 310 and the AF 302 can exchange information (e.g., UE position, application metrics, experienced data rates, and expected data rates).

FIG. 4 is an example signaling diagram 400 for multi-domain assisted QoE provisioning, according to one or more embodiments. FIG. 4 is a continuation of FIG. 3. At 402, the AF 302 can process the bottom model at the AF 302. For example, the AF can provide the UE position, application metrics, experienced data rates, and expected data rates to the bottom model at the AF 302 to generate intermediate results. At 404, the AF 302 can process the top model at the AF 302. For example, the AF 302 can provide the intermediate results generated by the bottom model at the NWDAF 306 and the intermediate results generated at the bottom model at the AF to the top model. The top model can generate a result that includes a QoE label metric. At step 406, the AF 302 can transmit configuration information (e.g., a new codec rate, an updated image recognition mode, or other appropriate information) to the UE 310. The UE 310 can use the configuration information to improve the QoE for an application.

It should be appreciated that during a training phase steps 340-346, step 402, and step 404 can be repeated until the accuracy of the top model reaches a threshold accuracy.

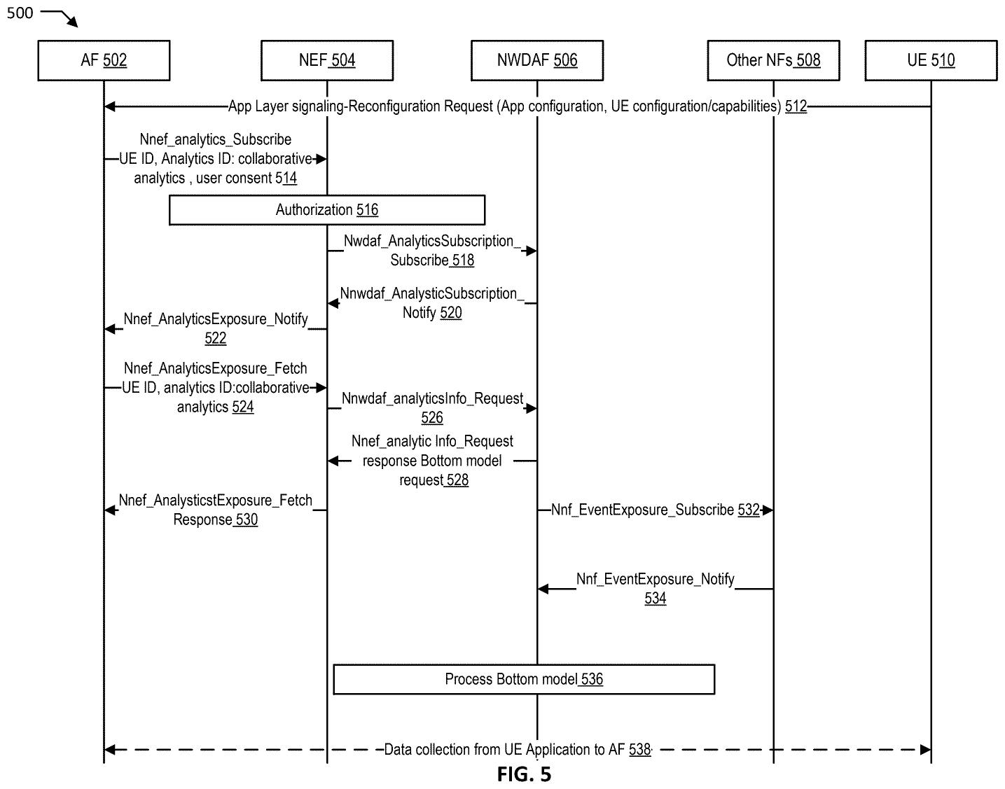

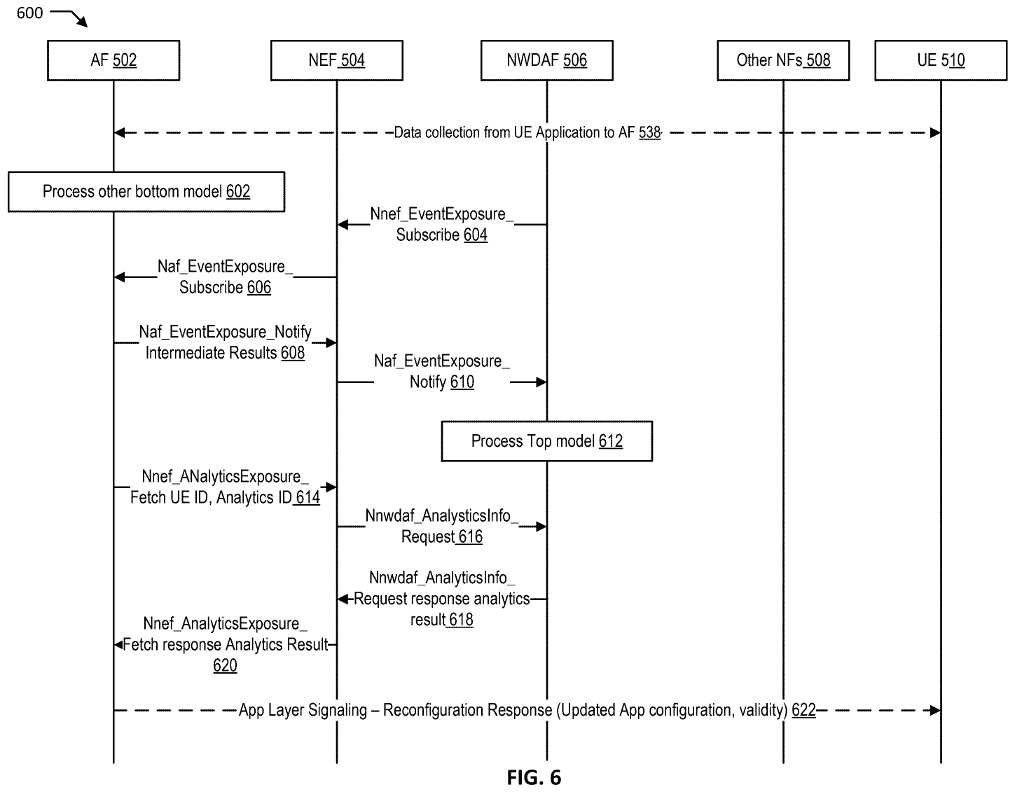

FIGS. 5 and 6 are collectively a signaling diagram for multi-domain assisted QoE provisioning, according to one or more embodiments. FIG. 6 is a continuation of FIG. 5. FIG. 5 is an example signaling diagram 500 for multi-domain assisted QoE provisioning, according to one or more embodiments. As illustrated, an AF 502 is in communication with a NEF 504, and NWDAF 506, other NFs 508, and a UE 510.

At 512, a machine learning client at the UE 310 can transmit a reconfiguration request (e.g., application reconfiguration, UE capability reconfiguration) via application layer signaling to the AF 502. This request can trigger a dynamic application configuration optimization by the AF 502. At 514, the AF 502 can request to subscribe to analytics information via the NEF 304. The request can include an analytics identifier that is associated with a request for collaborative analytics. The request can further include an indication of user consent for the collaborative analytics. At 516, the NEF 504 can determine whether the AF 502 is authorized for the analytics information subscription. If the AF 502 is authorized, for the analytics information subscription, then the NEF 504 subscribes to the analytics information from the NWDAF 506 at 518. If, however, the AF 502 is not authorized, then the NEF 504 does not subscribe to the information.

At 520, the NWDAF 506 can transmit the notification to the NEF 504 that the subscription is accepted for the analytics information to the NEF 504. At 522, the NEF 504 transmits a notification to the AF 502 that the subscription to the analytics information has been accepted. At 524, the AF 502 transmits a request to the NEF 504 to fetch the analytics information from the NWDAF 506. The request can include the UE identifier and analytics identifiers. At 526, the NEF 504 can transmit the request for the bottom model to the NWDAF 506.

At 528, the NWDAF 506 can transmit a bottom model from the AF 302 via the NEF 304. The NWDAF 506 can either transmit the bottom model, a bottom model ID, or a set of layers of the overall VFL model. At 530, the NEF 504 can transmit the bottom model to the AF 502. At 532, the NWDAF 506 can transmit a request to the other NFs 508 for information to be used to generate intermediate results. At 534, the other NFs can transmit information (e.g., RSRP information, a mean number of UEs registered in a network slice, a mean number of established packet data unit (PDU), resource utilization information of a network slice instance, reports of the total number of UEs served by the AMF per S-NSSAI, resource utilization information of a network slice instance) to be used to generate intermediate results.

At 536, the NWDAF 506 can use the bottom model at the NWDAF 506 to process the information to generate the intermediate results. At 538, the application at the UE 510 can provide information (e.g., UE position, application metrics, experienced data rates, and expected data rates) to the AF 502.

FIG. 6 is an example signaling diagram 600 for multi-domain assisted QoE provisioning, according to one or more embodiments. FIG. 6 is a continuation of FIG. 5. At 602, the AF can use the bottom model at the AF 602 to process information ((e.g., UE position, application metrics, experienced data rates, and expected data rates) and generate intermediate results. At 604, the NWDAF 506 can transmit a request for the intermediate results to the NEF 504. At 606, the NEF 504 can transmit the request for the intermediate results to the AF 502. At 608, the AF 502 can transmit the intermediate results to the NEF 504. At 610, the NEF 504 can transmit the intermediate results to the NWDAF 506.

At 612 the NWDAF 506 can process the intermediate results from the bottom model at the AF 502, and the intermediate results from the bottom model at the NWDAF 506 to a top model at the NWDAF 506 and generate a result (e.g., QoE label metric). At 614, the AF 502 can transmit a request for the top model result to the NEF 504. The request can include a UE ID and analytics ID. At 616, the NEF 504 can transmit the request for the top model result to the NWDAF 506. At 618, the NWDAF 506 can transmit the top model result to the NEF 504. At 620, the NEF 504 can transmit the top model result to the AF 502. At 622, the AF 502 can transmit configuration information (e.g., a new codec rate, an updated image recognition mode, or other appropriate information) to the UE 510. The UE 510 can use the configuration information to improve the QoE for an application.

In another embodiment, a VFL model can include sub-models (e.g., bottom models and a top model) at the AF and the CN. Each sub-model can operate on local information available at the respective domain (e.g., AF, CN). The VFL model can be used to generate customized analytics to pre-provision the network to support future QoE requirements for a user. The AF can perform network provisioning based on customized analytics that are generated via a VFL model that includes sub-models at the AF and the NWDAF. In these embodiments, a multi-domain VFL model can include a bottom model at the AF and another bottom model at the NWDAF. Each bottom model can respectively generate an intermediate results using local information. The bottom model at the AF can receive as input, UE context information, application information such as UE location, mobility information experienced data rate, expected data rate, and other appropriate information. The input to the bottom model at the AF can be associated with a single UE or a group of UEs (e.g., a group of UEs that belong to a cell or tracking area (TA), or other appropriate group). The bottom model at the NWDAF can receive as an input an RSRP, a mean number of UEs registered in a network slice, a mean number of established PDU sessions in a network slice, resource utilization information of a network slice instance, the total number of UEs that are served by the AMF per S-NSSAI, resource utilization information of a network slice instance obtained from the NRF. The intermediate results from the two bottom models can be transmitted to a top model at the NWDAF. The top model can generate an output that can include a network provisioning prediction (e.g., slice provisioning). The NWDAF can provide the provisioning prediction to the appropriate NF (e.g., network slice selection function (NSSF)). In this embodiment, the sub-models of the VFL model can be provided by either the AF or the NWDAF.

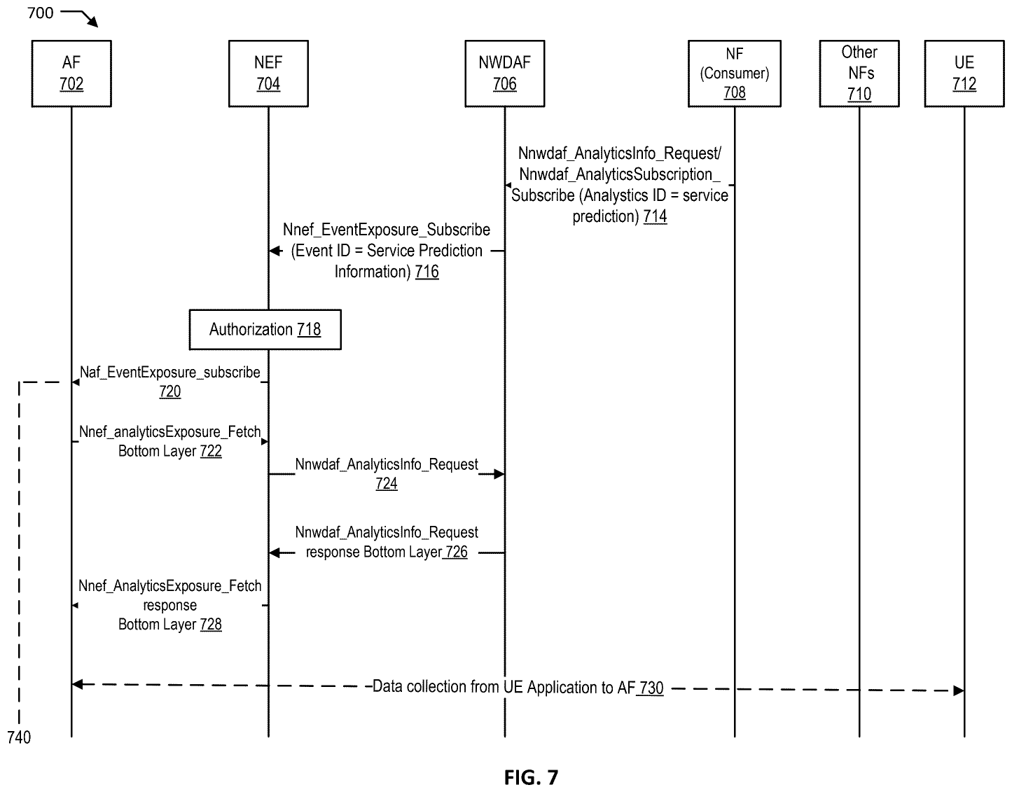

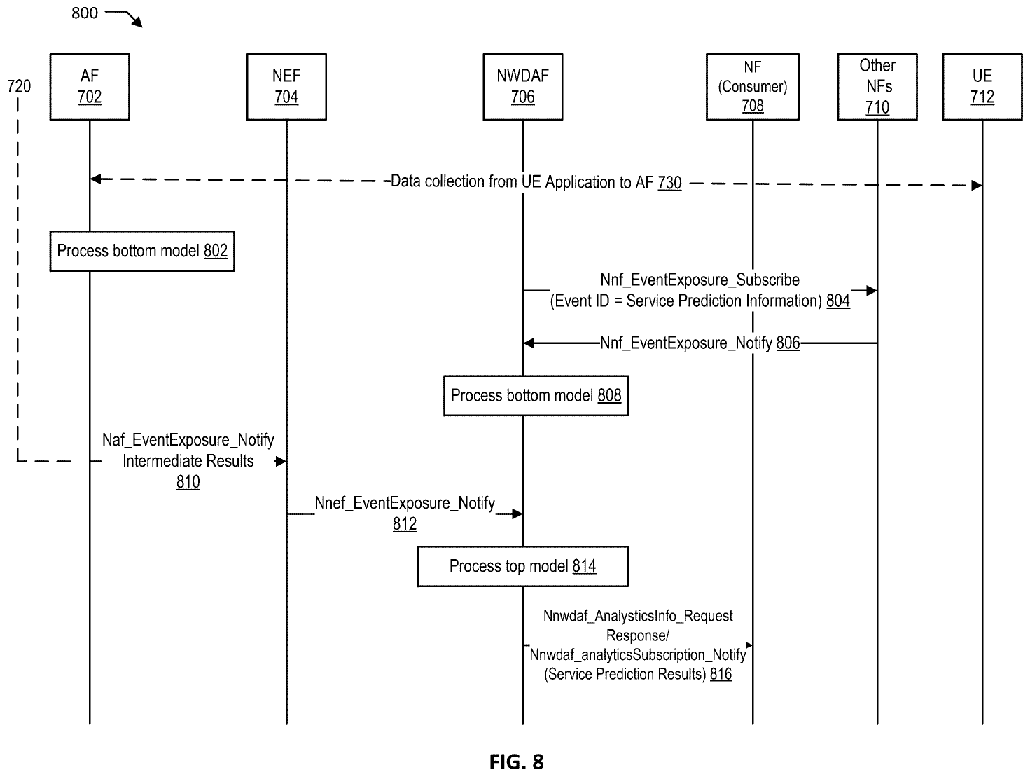

FIGS. 7 and 8 collectively form a signaling diagram for multi-domain assisted network provisioning. FIG. 7 is an example signaling diagram 700 for multi-domain assisted network provisioning, according to one or more embodiments. FIG. 8 is a continuation of FIG. 7. As illustrated, an AF 702 can be in communication with an NEF 704 and NWDAF 706, an NF consumer 708, other NFs 710 and a UE 712. At 714, the consumer NF 708 can transmit an analytics request/subscribe to the NWDAF 706. The request can include an analytics ID, which corresponds to a particular service prediction, targets UEs and optionally an area of interest. At 716, the NWDAF 706 can transmit a request to the NEF 704 for analytics information (e.g., UE context information, application information such as UE location, mobility information experienced data rate, expected data rate, and other appropriate information). At 718, the NEF 704 can determine whether the NWDAF 706 is authorized to receive the analytics information from the AF 702. At 720, the NEF 704 can transmit a request to the AF 702 for the analytics information.

At 722, the AF 702 can transmit a request for the bottom model from NWDAF 706 via the NEF 704. At 724, the NEF 704 can transmit the request for the bottom model from the AF 702 to the NWDAF 706. At 726, the NWDAF 706 can transmit a response to the NEF 704. The response can include either the bottom model, a bottom model ID, or a set of layers of the overall VFL model. At 728, the NEF 704 can transmit the response to the AF 702. At 730, the AF 702 can access information (e.g., UE position, application metrics, experienced data rates, and expected data rates) from the UE 712.

FIG. 8 is an example signaling diagram 800 for multi-domain assisted network provisioning, according to one or more embodiments. FIG. 8 is a continuation of FIG. 7. At 802, the AF 702 can use the bottom model at the AF 702 to process the information from the UE 712 and other inputs (e.g., available compute resources, available caching resources) and generates intermediate results. At 804, the NWDAF 706 can transmit a request to the other NFS 710 for information to be used to generate intermediate results. For example, the OAM can provide RSRP information, a mean number of UEs registered in a network slice, a mean number of established PDUs, resource utilization information of a network slice instance, or other appropriate information. The AMF can provide reports of the total number of UEs served by the AMF per S-NSSAI. The NRF can also provide resource utilization information of a network slice instance. At 808, the NWDAF 706 can provide the information to a bottom model at the NWDAF 706 to generate intermediate results. At 810, the AF 702 can provide the intermediate results generated by the bottom model at the AF 702 to the NEF 704. At 812, the NEF 704 can transmit the intermediate results to the NWDAF 706.

At 814, the NWDAF 706 can provide the intermediate results generated at the NWDAF 706 and the intermediate results generated at the AF 702 to the top model at the NWDAF 706 to generate a result (e.g., data analytics, such as service prediction results to the consumer NF, indicating whether the existing network configuration (e.g., slice provisioning) is expected to satisfy the user requirements of the user for a particular application). At 816, the NWDAF 706 can transmit the result to the appropriate NF(s) (e.g., the NF(s) that sent the request at 714).

In some instances, the VFL model may need to rely on sensitive UE information to have a top model generate a result. This sensitive data may not be shared with either the AF or the network. Based on the sensitivity of the data stored at the UE, the UE may operate in various modes. In a first mode, the UE can participate in the VFL. The UE can receive a bottom model from a model repository at either the AF or the NWDAF. The model at the UE can be locally trained at the UE. The UE can use the local bottom model to generate an intermediate results and forward the result to the top model, which can be at either the AF or the network. In a second mode, the UE can manage the VFL model. This second mode can be used in instances, that the information stored on the UE is more sensitive than the information stored with respect to the first mode, and it is not allowable to share the raw data stored on the UE or the trained model with either the AF or the network. In this second mode, the UE can provide the bottom models to the AF and the network. The AF and the network can generate intermediate results using their respective bottom models. The AF and the network can further transmit their intermediate results to the UE that uses a local top model to process the intermediate results and generate a result (e.g., customized analytics).

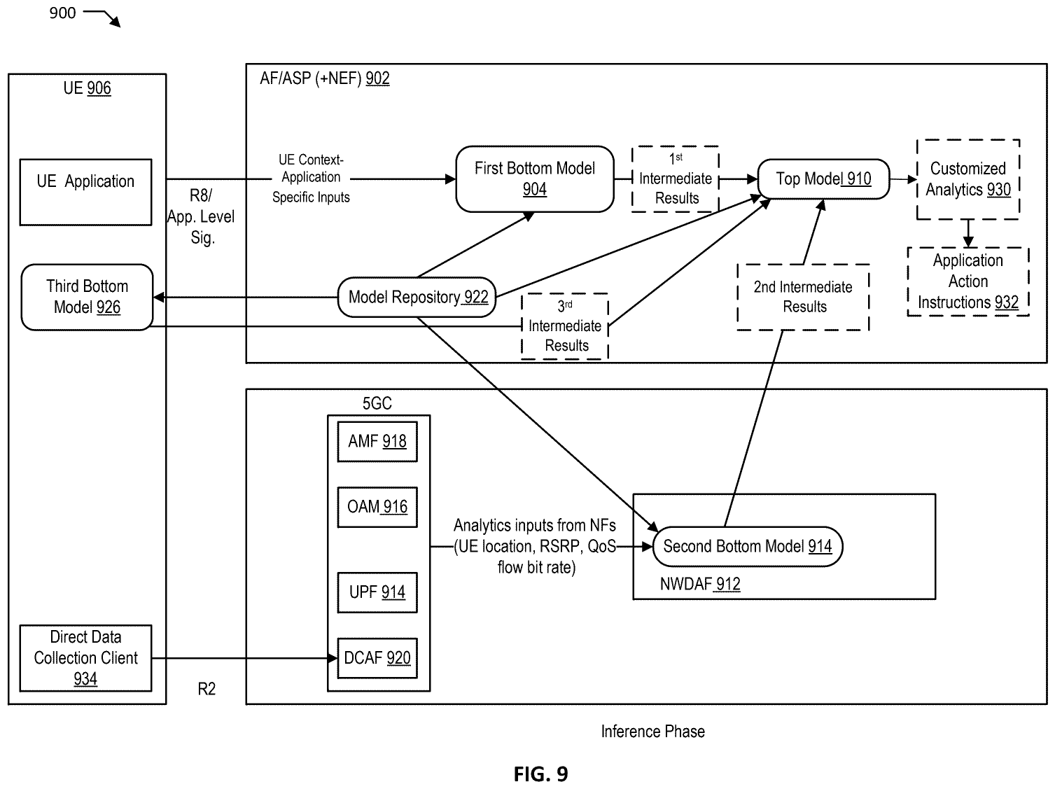

FIG. 9 is an illustration 900 of an example system for multi-domain assisted QoE provisioning, according to one or more embodiments. FIG. 9 can correspond to the first UE mode as described above. The AF 902 can include a first bottom model 904 that can receive UE context information and application specific inputs (e.g., UE position information, application metrics, experienced data rates and expected data rates) from the UE 906 and generate first intermediate results that is transmitted to the top model 910. The NWDAF 912 can include a second bottom model 914 can receive analytics inputs from various NFs and generate second intermediate results. For example, the OAM 916 can provide RSRP information, a mean number of UEs registered in a network slice, a mean number of established PDUs, resource utilization information of a network slice instance, or other appropriate information. Various NFs can also provide information. For example, the AMF 918 can provide reports of the total number of UEs served by the AMF 918 per S-NSSAI. The NRF can also provide resource utilization information of a network slice instance. Furthermore, a direct data collection client 934 can provide information to a DCAF 920, which can in turn provide information to the second bottom model 914. The NWDAF 912 can transmit the second intermediate results to the AF 902, which can provide the second intermediate results to the top model 910.

The AF 902 can include a model repository 922, from which the AF 902, the NWDAF 912, and the UE 906 can access a sub-model of the VFL model. For example, the AF 902 can access a first bottom model 04 and a top model 910 from the model repository 922, the NWDAF 912 can access the second bottom model 914 from the model repository 922, and the UE 906 can access the third bottom model 926 from the model repository 922. The UE 906 can further train the third bottom model 926 during a training phase and execute the model during an inference phase to generate intermediate results. The UE 906 can cause intermediate results of the third bottom model 926 to be transmitted to the top model 910. The top model 910 can use an intermediate results from each of the first bottom model 904, the second bottom model 914, and third bottom model 926 and output customized analytics 930 that can be used by the AF 902 to generate application action instructions 932. The application action instructions 932 can be used to reconfigure the UE application 906.

As illustrated, the model repository 922 is located at the AF 902. In another embodiment, the model repository 922 can be located at the NWDAF 912, and the NWDAF 912 provides the first bottom model 904 to the AF 902. Furthermore, the top model 910 can be at the NWDAF 912, and the NWDAF 912 can provide the output of the top model 910 to the AF 902. The AF 902 can then make one or more adjustments to the UE application to optimize the QoE based on the output from the top model 910. In another embodiment, each of the AF 902 and the NWDAF 912 can include a respective model repository. Therefore, each of the AF 902 and the NWDAF 912 can provide their own model. In this embodiment, the top model 910 can be in either the AF 902 or the NWDAF 912.

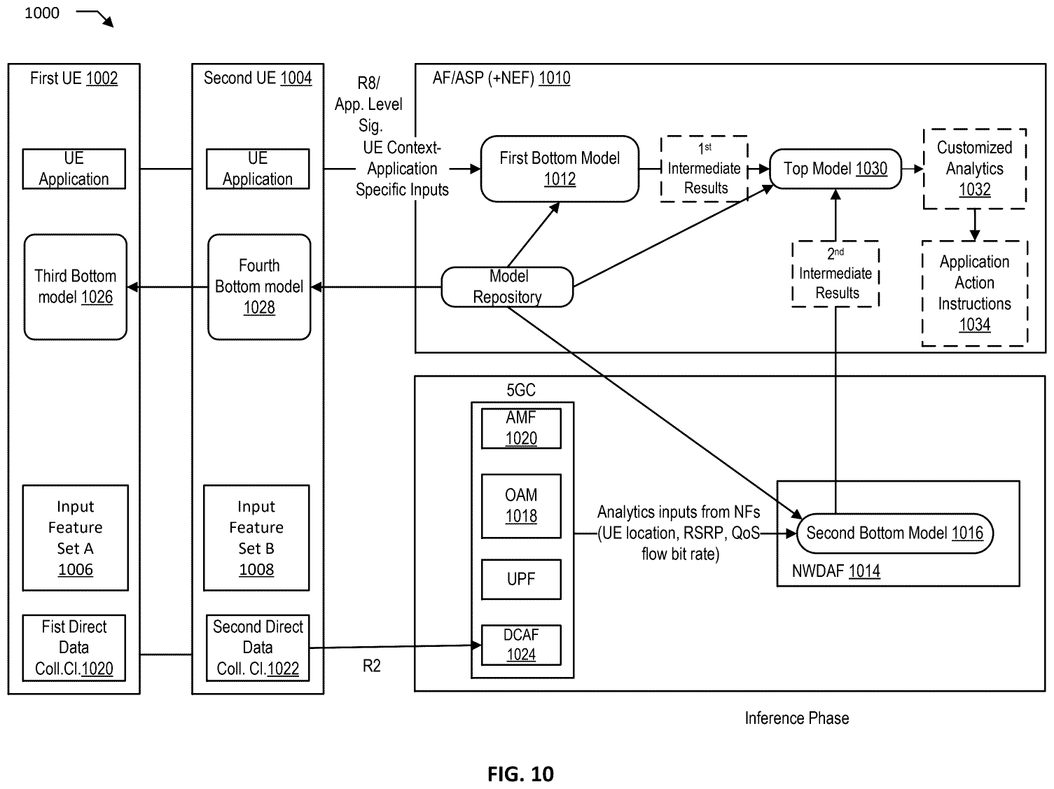

In some instances, the AF may receive UE context information and application specific inputs from multiple UEs. In these instances, there may need to be coordination amongst the UEs for exchanging information while maintaining the privacy of locally stored information. FIG. 10 illustrates an example of this scenario.

FIG. 10 is an illustration 1000 of an example system for multi-domain assisted QoE provisioning, according to one or more embodiments. Each of the first UE 1002 and the second UE 1004 can be provisioned with a respective input feature set (e.g., input feature set A 1006, input feature set B 1008). The feature sets can be selected and provisioned at the UE by the network or by the respective UE itself. For example, if the first UE 1002 is in a different location than the second UE 1004, a user of the first UE 1002 and a user of the second UE 1004 can respectively configure their UEs to have location-based input feature set.

In this embodiment, the AF 1010 can include a first bottom model 1012 that can receive UE context information and application specific inputs (e.g., UE position information, application metrics, experienced data rates and expected data rates) from the first UE 1002 and the second UE 1004 to generate first intermediate results that is transmitted to the top model 910. The NWDAF 1014 can include a second bottom model 1016 can receive analytics inputs from various NFs and generate second intermediate results. For example, the OAM 1018 can provide RSRP information, a mean number of UEs registered in a network slice, a mean number of established PDUs, resource utilization information of a network slice instance, or other appropriate information. Various NFs can also provide information. For example, the AMF 1020 can provide reports of the total number of UEs served by the AMF 1020 per S-NSSAI. The NRF can also provide resource utilization information of a network slice instance. Furthermore, a first direct data collection client 1020 and a second direct data collection client 1022 can provide information to a DCAF 1024, which can in turn provide information to the second bottom model 1016 to generate second intermediate results.

In some embodiments, the first UE 1002 can use a third bottom model 1026 input feature set A 1006 to generate a third intermediate results. The second UE 1004 can use a fourth bottom model 1028 and input feature set B 1008 to generate fourth intermediate results. The respective feature set to generate a third intermediate results. The second UE 1004 can combine the third intermediate results and the fourth intermediate results and transmit the combined results to a top model 1030. As illustrated, the top model 1030 is located at the AF 1010. However, it should be appreciated that the top model 1030 can be located that the NWDAF 1014 as indicated above. The top model 1030 can use the first intermediate results, the second intermediate results and the combined third and fourth intermediate results to generate an output (e.g., customized analytics 1032) that can be used to generate application action instructions 1034.

In some embodiments, the first UE 1002 can use a third bottom model 1026 input feature set A 1006 to generate a third intermediate results. The second UE 1004 can use a fourth bottom model 1028 and input feature set B 1008 to generate fourth intermediate results. Each of the first UE 1002 and the second UE 1004 can separately transmit their intermediate results to the AF 1010 or the NWDAF 1014 depending on where the top model 1030 is located. The entity (e.g., AF 1010, NWDAF 1014) that receives the third intermediate results and the fourth intermediate results can process the results, and send the processed result along with processed first intermediate results and second intermediate results to the top model 1030 to generate an output.

In each of the embodiments, based on the output of the top model 1030, either the network or the AF 1010 can configure the first UE 1002 and the second UE 1004 to re-configure their respective input feature set A 1006 and input feature set B 1008.

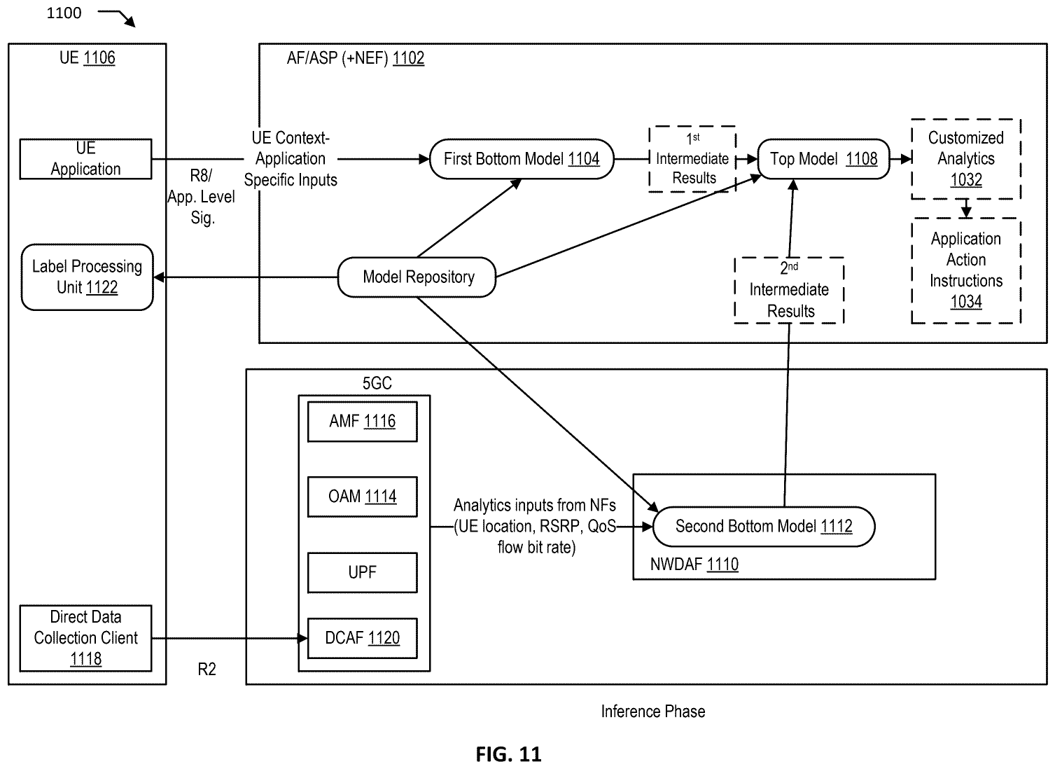

In some instances, a UE may not be able to share its labels with either the AF or the network. In these instances, the UE can participate in the VFL model during a training phase. During training, the UE can perform label processing. This can include comparing a top model output value with a value of a metric to be predicted and determining a label based on the comparison. Therefore, a top model at the AF or the NWDAF may generate an output value, but the top model determine the label that corresponds to the output value. The UE can then use a loss function to determine an updated gradient for the top model and transmit the gradient back to the top model. During an inference phase, the UE can receive the output value from a top model at either the AF or the NWDAF. FIG. 11 is an illustration that corresponds to these instances. FIG. 11 is an illustration of this embodiment.

In this embodiment, the AF 1102 can include a first bottom model 1104 that can receive UE context information and application specific inputs (e.g., UE position information, application metrics, experienced data rates and expected data rates) from the UE 1106 to generate first intermediate results that is transmitted to the top model 1108. The NWDAF 1110 can include a second bottom model 1112 that can receive analytics inputs from various NFs and generate second intermediate results. For example, the OAM 1018 can provide RSRP information, a mean number of UEs registered in a network slice, a mean number of established PDUs, resource utilization information of a network slice instance, or other appropriate information. Various NFs can also provide information. For example, the AMF 1116 can provide reports of the total number of UEs served by the AMF 1116 per S-NSSAI. The NRF can also provide resource utilization information of a network slice instance. Furthermore, a first direct data collection client 1118 can provide information to a DCAF 1120, which can in turn provide information to the second bottom model 1112 to generate second intermediate results.

As illustrated, the top model 1108 is located at the AF 1102. However, it should be appreciated that the top model 1108 can be located at the NWDAF 1110, as indicated above. The top model 1108 can use the first intermediate results, the second intermediate results to generate an output (e.g., a metric value). The AF 1102 can transmit the output to a label processing unit 1122 of the UE 1106. The label processing unit 1122 can compare the current and predicted metric values (e.g., battery consumption, load time, network performance, or other QoE label) and produce an error value for backward propagation.

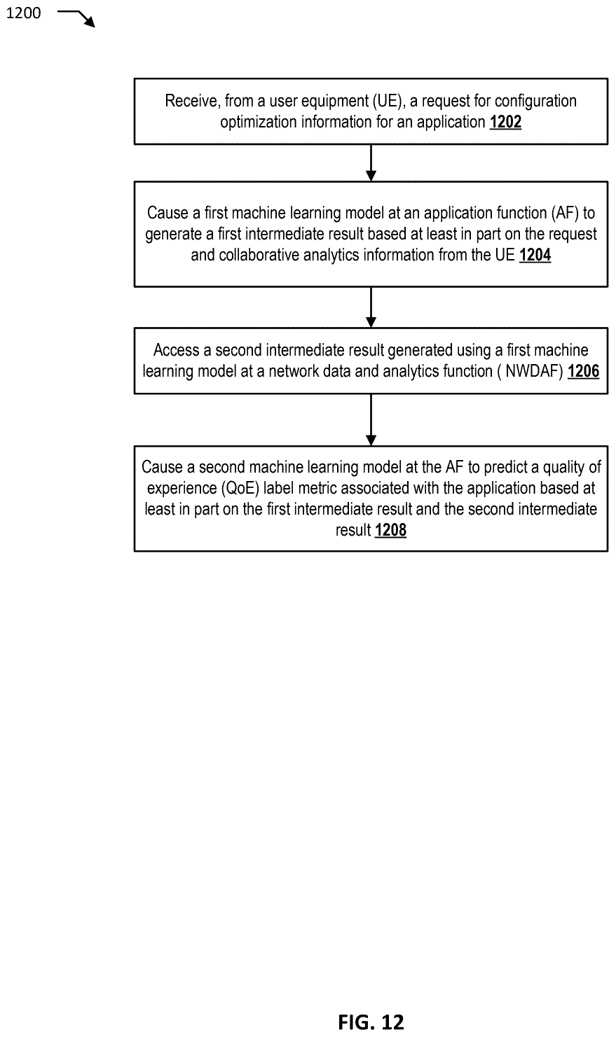

FIG. 12 is an example process flow 1200 for multi-domain assisted QoE provisioning, according to one or more embodiments. A 1202, a method can include UE receiving a request for configuration optimization information for an application.

At 1204, the method can include causing a first machine learning model at an AF to generate first intermediate results based at least in part on the request and collaborative analytics information from the UE. The collaborative analytics information can include UE context information and application information. The UE context information can include UE mobility information or UE location information. The application information can include an application data rate, buffer capacity, or available processing capacity.

At 1206, the method can include accessing second intermediate results generated using a first machine learning model at a NWDAF. The first machine learning model can be selected by the AF from a model repository stored at the AF based at least in part on the QoE label metric.

At 1208, the method can include causing a second machine learning model at the AF to predict a QoE label metric associated with the application based at least in part on the first intermediate results and the second intermediate results. The AF can adjust an application configuration based at least in part on the predicted QoE label metric. The adjustment can occur as a user is interacting with the application.

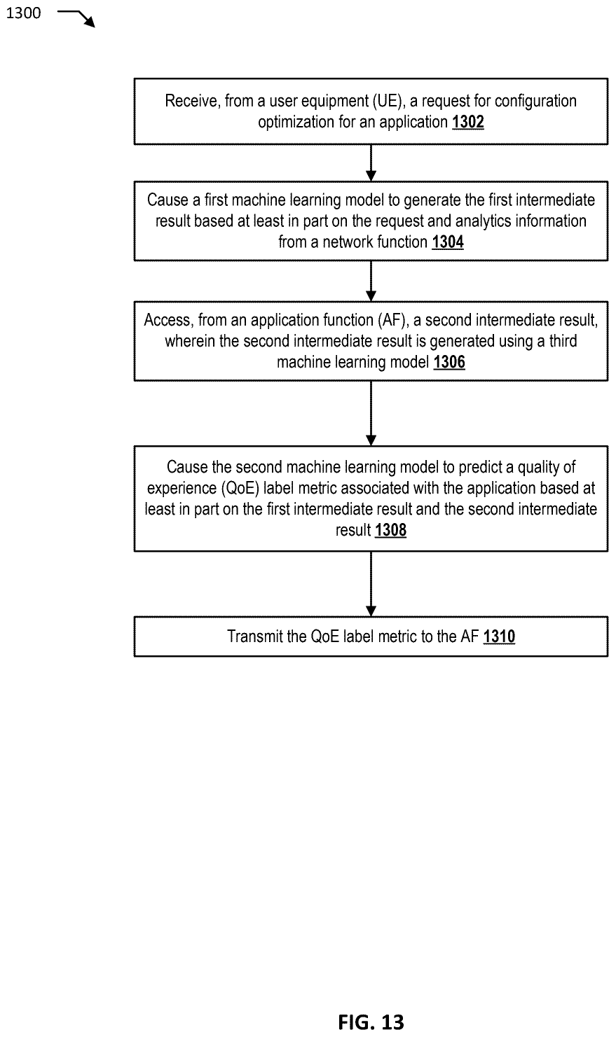

FIG. 13 is an example process flow 1300 for multi-domain assisted QoE provisioning, according to one or more embodiments. At 1302, a method can include receiving, from a UE, a request for configuration optimization for an application.

At 1304, the method can include causing a first machine learning model to generate the first intermediate results based at least in part on the request and analytics information from a network function. The analytics information from the network function comprises a RSRP, a mean number of UEs registered in a network slice, a mean number of established PDU sessions in a network slice, or resource utilization information of a network slice.

At 1306, the method can include accessing, from an AF, second intermediate results. The second intermediate results can be generated using a third machine learning model. The third machine learning model can be selected by the NWDAF from a model repository stored at the NWDAF based at least in part on the QoE label metric.

At 1308, the method can include causing the second machine learning model to predict a QoE label metric associated with the application based at least in part on the first intermediate results and the second intermediate results.

At 1310, the method can include transmitting the QoE label metric to the AF. The AF can adjust an application configuration based at least in part on the predicted QoE label metric. The adjustment can occur as a user is interacting with the application.

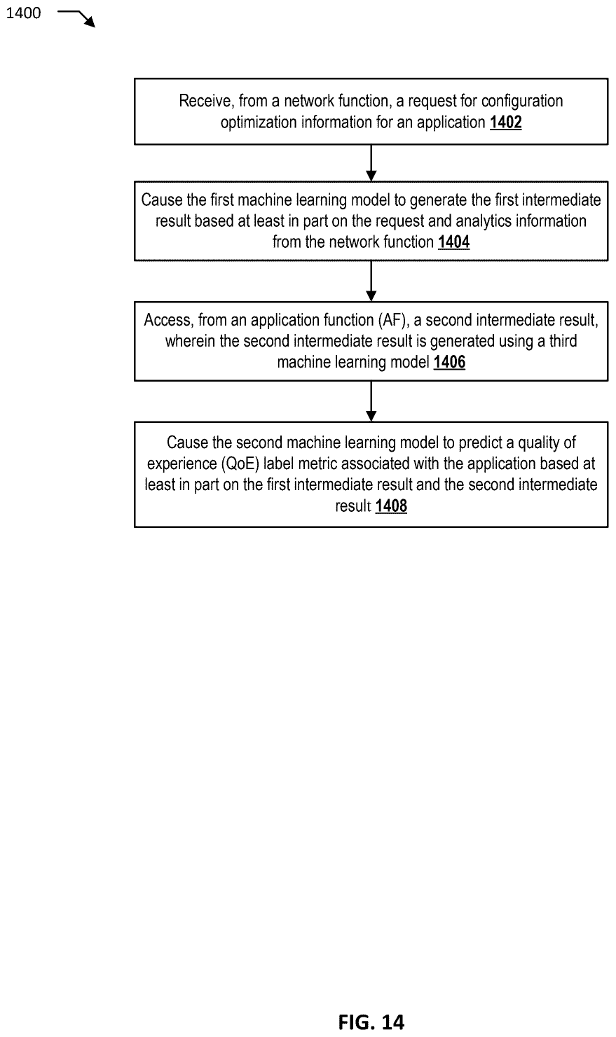

FIG. 14 is an example process flow 1400 for multi-domain assisted QoE provisioning, according to one or more embodiments. At 1402, a method can include receiving, from a network function, a request for configuration optimization information for an application.

At 1404, the method can include causing the first machine learning model to generate the first intermediate results based at least in part on the request and analytics information from the network function.

At 1406, the method can include accessing, from an AF, second intermediate results, wherein the second intermediate results are generated using a third machine learning model. The NWDAF, can select the third machine learning model from the model repository based at least in part on the QoE label metric.

At 1408, the method can include causing the second machine learning model to predict a QoE label metric associated with the application based at least in part on the first intermediate results and the second intermediate results. The QoE label metric can be transmitted from the NWDAF to the network function.

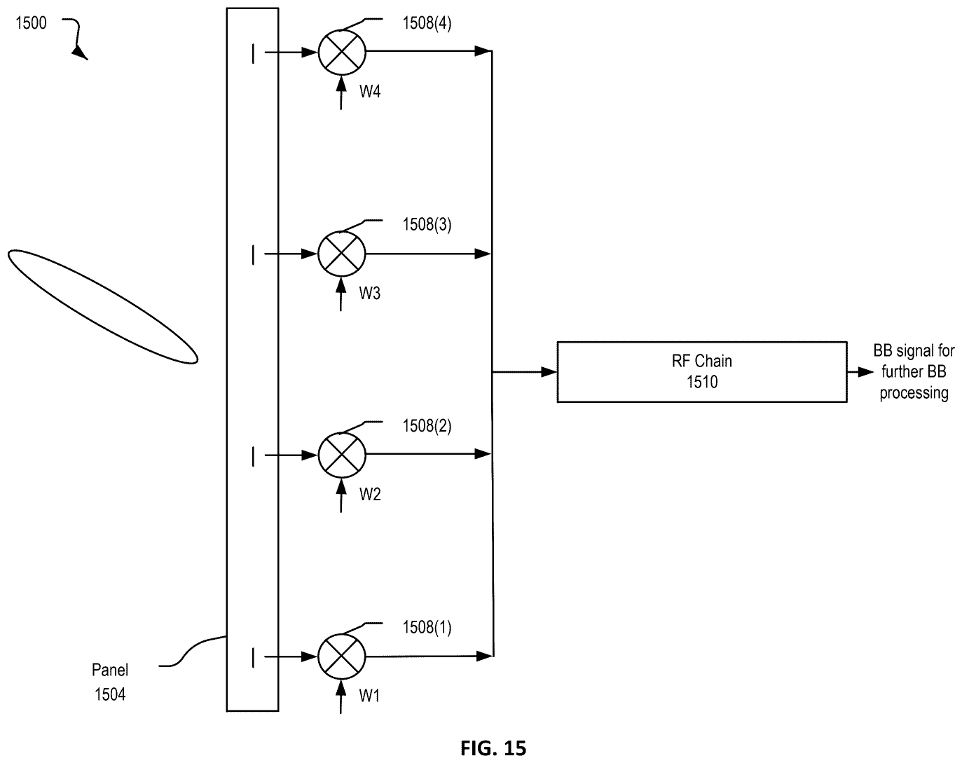

FIG. 15 illustrates receive components 1500 of the UE 1506, in accordance with some embodiments. The receive components 1500 may include an antenna panel 1504 that includes a number of antenna elements. The panel 1504 is shown with four antenna elements, but other embodiments may include other numbers.

The antenna panel 1504 may be coupled to analog beamforming (BF) components that include a number of phase shifters 1508(1)-1508(4). The phase shifters 1508(1)-1508(4) may be coupled with a radio-frequency (RF) chain 1513. The RF chain 1513 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1508(1)-1508(4) to provide a receive beam at the antenna panel 1504. These BF weights may be determined based on the channel-based beamforming.

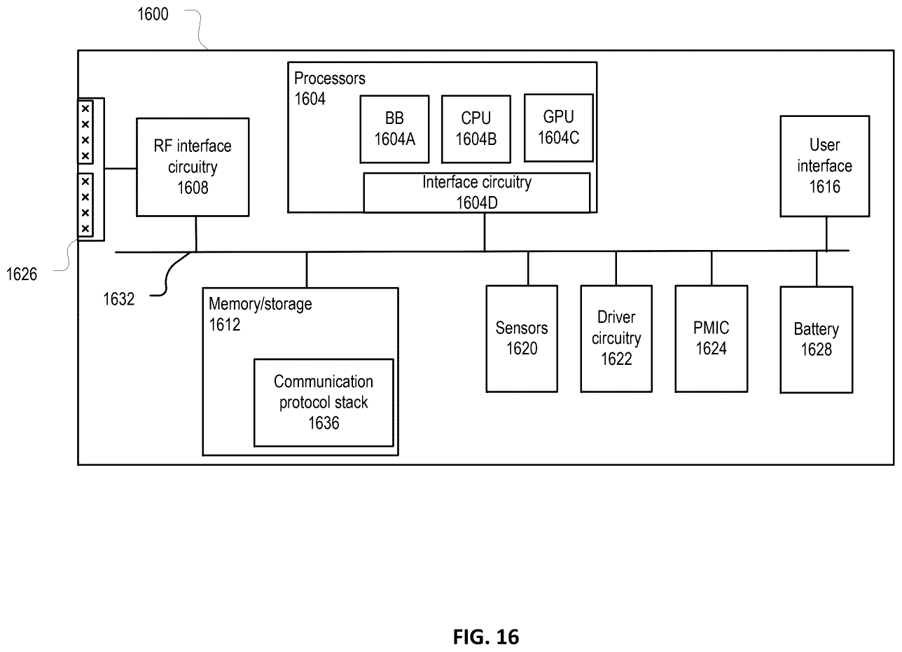

FIG. 16 illustrates a UE 1600, in accordance with some embodiments. The UE 1600 may be similar to and substantially interchangeable with UE 108 of FIG. 1.

The processors 1604 may include processor circuitry such as, for example, baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1612 to cause the UE 1600 to perform delay-adaptive operations as described herein. The processors 1604 may also include interface circuitry 1604D to communicatively couple the processor circuitry with one or more other components of the UE 1600.

In some embodiments, the baseband processor circuitry 1604A may access a communication protocol stack 1636 in the memory/storage 1612 to communicate over a 3GPP compatible network. In general, the baseband processor circuitry 1604A may access the communication protocol stack 1636 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1612 may include one or more non-transitory, computer-readable media that includes instructions (for example, communication protocol stack 1636) that may be executed by one or more of the processors 1604 to cause the UE 1600 to perform various delay-adaptive operations described herein.

The memory/storage 1612 includes any type of volatile or non-volatile memory that may be distributed throughout the UE 1600. In some embodiments, some of the memory/storage 1612 may be located on the processors 1604 themselves (for example, memory/storage 1612 may be part of a chipset that corresponds to the baseband processor circuitry 1604A), while other memory/storage 1612 is external to the processors 1604 but accessible thereto via a memory interface. The memory/storage 1612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1608 may include transceiver circuitry and a radio frequency front module (RFEM) that allows the UE 1600 to communicate with other devices over a radio access network. The RF interface circuitry 1608 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1626 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1626.

In various embodiments, the RF interface circuitry 1608 may be configured to transmit/receive signals in a manner compatible with NR access technologies.

The antenna 1626 may include antenna elements to convert electrical signals into radio waves to travel through the air and to convert received radio waves into electrical signals. The antenna elements may be arranged into one or more antenna panels. The antenna 1626 may have antenna panels that are omnidirectional, directional, or a combination thereof to enable beamforming and multiple input, multiple output communications. The antenna 1626 may include microstrip antennas, printed antennas fabricated on the surface of one or more printed circuit boards, patch antennas, or phased array antennas. The antenna 1626 may have one or more panels designed for specific frequency bands including bands in FR1 or FR2.

The user interface 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1600.

The sensors 1620 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within, or connected to, the UE 1600. For example, driver circuitry 1622 may include a display driver to control and allow access to a display device, a touchscreen driver to control and allow access to a touchscreen interface, sensor drivers to obtain sensor readings of sensors 1620 and control and allow access to sensors 1620, drivers to obtain actuator positions of electro-mechanic components or control and allow access to the electro-mechanic components, a camera driver to control and allow access to an embedded image capture device, audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

A battery 1628 may power the UE 1600, although in some examples the UE 1600 may be mounted deployed in a fixed location and may have a power supply coupled to an electrical grid. The battery 1628 may be a lithium ion battery, a metal-air battery, such as a zinc-air battery, an aluminum-air battery, a lithium-air battery, and the like. In some implementations, such as in vehicle-based applications, the battery 1628 may be a typical lead-acid automotive battery.

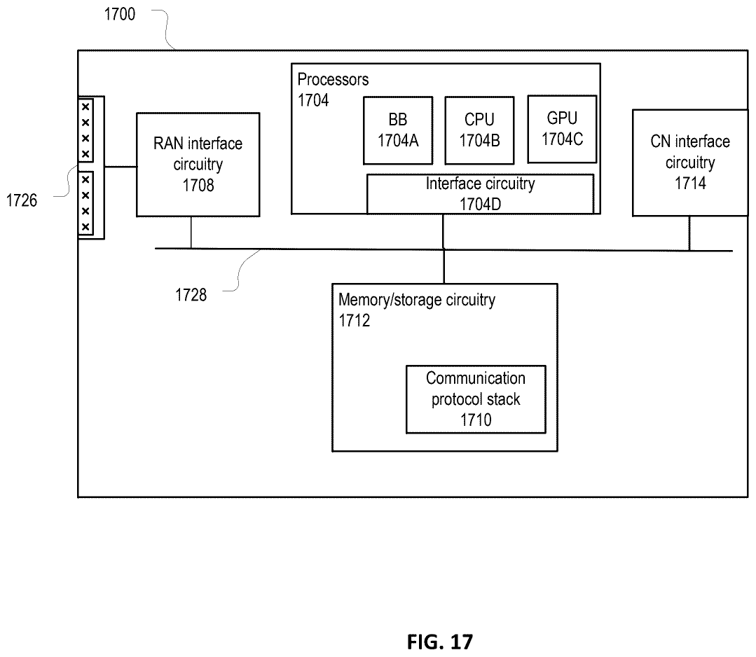

FIG. 17 illustrates a network device 1700 in accordance with some embodiments. The network device 1700 may be similar to and substantially interchangeable with base station or a device of the core network or external data network.

The network device 1700 may include processors 1704, RF interface circuitry 1708 (if implemented as a base station), core network (CN) interface circuitry 1714, memory/storage circuitry 1712, and antenna structure 1726.

The components of the network device 1700 may be coupled with various other components over one or more interconnects 1728.

The processors 1704, RF interface circuitry 1708, memory/storage circuitry 1712 (including communication protocol stack 1710), antenna structure 1726, and interconnects 1728 may be similar to like-named elements shown and described with respect to FIG. 16.

The processors 1704 may include processor circuitry such as, for example, baseband processor circuitry (BB) 1704A, central processor unit circuitry (CPU) 1704B, and graphics processor unit circuitry (GPU) 1704C. The processors 1704 may include any type of circuitry or processor circuitry that executes or otherwise operates computer-executable instructions, such as program code, software modules, or functional processes from memory/storage circuitry 1712 to cause the UE to perform delay-adaptive operations as described herein. The processors 1704 may also include interface circuitry 1704D to communicatively couple the processor circuitry with one or more other components of the network device 1700.

The CN interface circuitry 1714 may provide connectivity to a core network, for example, a 5th Generation Core network (5GC) using a 5GC-compatible network interface protocol such as carrier Ethernet protocols, or some other suitable protocol. Network connectivity may be provided to/from the network device 1700 via a fiber optic or wireless backhaul. The CN interface circuitry 1714 may include one or more dedicated processors or FPGAs to communicate using one or more of the aforementioned protocols. In some implementations, the CN interface circuitry 1714 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

### In the Following Sections, Further Example Embodiments are Provided.

Example 1 includes a method comprising: receiving, from a user equipment (UE), a request for configuration optimization information for an application; causing a first machine learning model at an application function (AF) to generate first intermediate results based at least in part on the request and collaborative analytics information from the UE; accessing second intermediate results generated using a second machine learning model at a network data and analytics function (NWDAF); and causing a third machine learning model at the AF to predict a quality of experience (QoE) label metric associated with the application based at least in part on the first intermediate results and the second intermediate result.
Example 2 includes the method of example 1, wherein the collaborative analytics information comprises UE context information and application information.
Example 3 incudes the method of example 2, wherein the UE context information comprises UE mobility information or UE location information, and wherein the application information comprises an application data rate, buffer capacity, or available processing capacity.
Example 4 includes the method of any of examples 1-3, wherein the method further comprises: selecting, by the AF, the first machine learning model from a model repository stored at the AF based at least in part on the QoE label metric; selecting, by the AF, the second machine learning model from the model repository based at least in part on the QoE label metric; and transmitting, by the AF and to the NWDAF, the second machine learning model for predicting the second intermediate results.
Example 5 includes the method of any of examples 1-4, wherein the method further comprises: adjusting an application configuration based at least in part on the QoE label metric.
Example 6 includes the method of any of examples 1-5, wherein the method further comprises: aligning an external identifier of the UE with an internal identifier of the UE, wherein the collaborative analytics information is based at least in part on the alignment.
Example 7 includes the method of any of examples 1-6, wherein the method further comprises: providing an identifier of the third machine learning model to the NWDAF, wherein the NWDAF accesses the third machine learning model from a model repository based at least in part on the identifier.
Example 8 can include an apparatus comprising: memory having instructions; processing circuitry coupled with the memory to execute the instructions to perform the steps of any of the examples 1-7.
Example 9 can include one or more non-transitory, computer-readable media including instructions that, when executed, cause an apparatus to perform the steps of any of examples 1-7.
Example 10 can include a method performed by a network data and analytics function (NWDAF), the method comprising: receiving, from a user equipment (UE), a request for configuration optimization for an application; causing a first machine learning model to generate first intermediate results based at least in part on the request and analytics information from a network function; accessing, from an application function (AF), second intermediate results, wherein the second intermediate results are generated using a second machine learning model; causing a third machine learning model to predict a quality of experience (QoE) label metric associated with the application based at least in part on the first intermediate results and the second intermediate results; and transmitting the QoE label metric to the AF.
Example 11 can include the method of example 10, wherein the analytics information from the network function comprises a reference signal reference power (RSRP), a mean number of UEs registered in a network slice, a mean number of established PDU sessions in a network slice, or resource utilization information of a network slice.
Example 12 can include the method any of examples 10 or 11, wherein the method further comprises: selecting, by the NWDAF, the first machine learning model from a model repository stored at the NWDAF based at least in part on the QoE label metric; selecting, by the NWDAF, a third machine learning model from the model repository based at least in part on the QoE label metric; and transmitting, by the NWDAF to the AF, the first machine learning model for predicting the first intermediate results to be used for predicting the QoE label metric by the second machine learning model.
Example 13 can include the method any of examples 10-12, wherein the method further comprises: adjusting an application configuration based at least in part on the QoE label metric.
Example 14 can include the method any of examples 10-13, wherein the method further comprises: providing an identifier of the third machine learning model to the AF, wherein the AF accesses the third machine learning model from a model depository at the NWDAF based at least in part on the identifier.
Example 15 can include an apparatus comprising: memory having instructions; processing circuitry coupled with the memory to execute the instructions to perform the steps of any of the examples 10-14.
Example 16 can include one or more non-transitory, computer-readable media including instructions that, when executed, cause an apparatus to perform the steps of any of examples 10-14.
Example 17 can include a method performed by network data and analytics function (NWDAF), the method comprising: receiving, from a network function, a request for configuration optimization information for an application; causing a first machine learning model to generate first intermediate results based at least in part on the request and analytics information from the network function; accessing, from an application function (AF), second intermediate results, wherein the second intermediate results are generated using a second machine learning model; causing a third machine learning model to predict a quality of experience (QoE) label metric associated with the application based at least in part on the first intermediate results and the second intermediate results.
Example 18 can include the method of example 17, wherein the method further comprises: transmitting the QoE label metric from the NWDAF to the network function.
Example 19 can include the method of any of examples 17 or 18, wherein the method further comprises: selecting, by the NWDAF, the first machine learning model from a model repository stored at the NWDAF based at least in part on the QoE label metric; selecting, by the NWDAF, the second machine learning model from the model repository based at least in part on the QoE label metric; and transmitting, by the NWDAF to the AF, the second machine learning model for predicting the second intermediate results to be used for predicting the QoE label metric.
Example 20 can include the method of any of examples 17-19, wherein the method further comprises: selecting, by the NWDAF, the third machine learning model from a model repository based at least in part on the QoE label metric.
Example 21 can include the method of any of examples 17-20, wherein the analytics information from the network function comprises a reference signal reference power (RSRP), a mean number of UEs registered in a network slice, a mean number of established PDU sessions in a network slice, or resource utilization information of a network slice.
Example 22 can include an apparatus comprising: memory having instructions; processing circuitry coupled with the memory to execute the instructions to perform the steps of any of the examples 17-20.
Example 23 can include one or more non-transitory, computer-readable media including instructions that, when executed, cause an apparatus to perform the steps of any of examples 17-20.
Example 24 can include a method performed by an application function (AF), the method comprising: causing a first machine learning model to generate first intermediate results based at least in part on collaborative analytics information from a user equipment (UE); accessing, from a network data and analytics function (NWDAF), second intermediate results, wherein the second intermediate results are generated using a second machine learning model; accessing, from the UE, a third intermediate results, wherein the third intermediate results are generated using a third machine learning model; and causing a fourth machine learning model to predict a quality of experience (QoE) label metric associated with an application based at least in part on the first intermediate results, the second intermediate results, and the third intermediate results.
Example 25 can include the method of example 24, wherein the collaborative analytics information comprises UE context information and application information.
Example 26 can include the method of example 25, wherein the UE context information comprises UE mobility information or UE location information; and wherein the application information comprises an application data rate, buffer capacity, or available processing capacity.
Example 27 can include the method of any of examples 24-26, wherein the method further comprises: selecting, by the AF, the third machine learning model from a model repository based at least in part on the QoE label metric; and transmitting, by the AF and to the UE, the third machine learning model for predicting the third intermediate results to be used for predicting the QoE label metric.
Example 28 can include the method of any of examples 24-27, wherein the method further comprises: adjusting an application configuration based at least in part on the QoE label metric.
Example 29 can include an apparatus comprising: memory having instructions; processing circuitry coupled with the memory to execute the instructions to perform the steps of any of the examples 24-28.
Example 30 can include one or more non-transitory, computer-readable media including instructions that, when executed, cause an apparatus to perform the steps of any of examples 24-28.
Example 31 can include a method performed by a network data and analytics function (NWDAF), the method comprising: causing a first machine learning model to generate first intermediate results based at least in part on analytics information from a network function; accessing, from an application function (AF), second intermediate results, wherein the second intermediate results are generated using a second machine learning model at the NWDAF; transmitting, by the NWDAF, the first intermediate results to a user equipment (UE); transmitting, by the NWDAF, the second intermediate results to the UE; and accessing, by the NWDAF and from the UE, a quality of experience (QoE) label metric.
Example 32 can include the method of example 31, wherein the analytics information from the network function comprises a reference signal reference power (RSRP), a mean number of UEs registered in a network slice, a mean number of established PDU sessions in a network slice, or resource utilization information of a network slice.
Example 33 can include the method of any of examples 31 or 32, wherein the method further comprises: selecting, by the NWDAF, a third machine learning model from a model repository based at least in part on the QoE label; and transmitting, by the NWDAF and to the UE, the third machine learning model for predicting the third intermediate results to be used for predicting the QoE label metric.
Example 34 can include the method of any of examples 31-33, wherein the method further comprises: selecting, by the UE, the second machine learning model from a model repository based at least in part on the QoE label metric; transmitting, by the UE and to the AF, the second machine learning model for predicting the first intermediate results.
Example 35 can include the method of any of examples 31-34, wherein the method further comprises: adjusting an application configuration based at least in part on the QoE label metric.
Example 36 can include an apparatus comprising: memory having instructions; processing circuitry coupled with the memory to execute the instructions to perform the steps of any of the examples 31-35.
Example 37 can include one or more non-transitory, computer-readable media including instructions that, when executed, cause an apparatus to perform the steps of any of examples 31-35.
Example 38 can include a method performed by an application function (AF), the method comprising: causing a first machine learning model to generate first intermediate results based at least in part on first collaborative analytics information from a first user equipment (UE) and second collaborative analytics information from a second UE, wherein the first UE is provisioned with a first feature set to be used to identify the first collaborative analytics information, wherein the second UE is provisioned with a second feature set to be used to identify the second collaborative analytics information; accessing, from a network data and analytics function (NWDAF), second intermediate results, wherein the second intermediate results are generated using a second machine learning model; accessing third intermediate results from the first UE, wherein the third intermediate results are generated using a third machine learning model; accessing fourth intermediate results from the second UE, wherein the fourth intermediate results are generated using a fourth machine learning model; and causing a fifth machine learning model to predict a quality of experience (QoE) label metric associated with an application based at least in part on the first intermediate results and the second intermediate results.
Example 39 can include the method of example 38, wherein the method further comprises: aggregating the first collaborative analytics information and the second collaborative analytics information, wherein the first machine learning model is provided an aggregated first collaborative analytics information and second collaborative analytics information.
Example 40 can include the method of any of examples 38 or 39, wherein the method further comprises: selecting, by the AF, the first machine learning model from a model repository stored at the AF based at least in part on the QoE label metric; selecting, by the AF, the third machine learning model from the model repository based at least in part on the QoE label; and transmitting, by the AF and to the NWDAF, the third machine learning model for predicting the second intermediate results to be used for predicting the QoE label by the second machine learning model.
Example 41 can include the method of any of examples 38-40, wherein the method further comprises: adjusting an application configuration based at least in part on the QoE label metric.
Example 42 can include an apparatus comprising: memory having instructions; processing circuitry coupled with the memory to execute the instructions to perform the steps of any of the examples 38-41.
Example 43 can include one or more non-transitory, computer-readable media including instructions that, when executed, cause an apparatus to perform the steps of any of examples 38-41.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a request for configuration optimization information for an application;
causing a first machine learning model to generate a first intermediate result based at least in part on the request and collaborative analytics information;
accessing a second intermediate result generated using a second machine learning model at a network data and analytics function (NWDAF); and
causing a third machine learning model to predict a quality of experience (QoE) label metric associated with the application based at least in part on the first intermediate result and the second intermediate result.

2. The method of claim 1, wherein the collaborative analytics information comprises user equipment (UE) context information and application information.

3. The method of claim 2, wherein the UE context information comprises UE mobility information or UE location information, and wherein the application information comprises an application data rate, a buffer capacity, or an available processing capacity.

4. The method of claim 1, wherein the method further comprises:
selecting the first machine learning model from a model repository stored at an application function (AF) based on the QoE label metric;
selecting the second machine learning model from the model repository based on the QoE label metric; and
causing transmission to the NWDAF of the second machine learning model for predicting the second intermediate result.

5. The method of claim 1, wherein the method further comprises:
adjusting an application configuration based at least in part on the QoE label metric.

6. The method of claim 1, wherein the method further comprises:
aligning an external identifier of a user equipment (UE) with an internal identifier of the UE, wherein the collaborative analytics information is based at least in part on the alignment.

7. The method of claim 1, wherein the method further comprises:
providing an identifier of the third machine learning model to the NWDAF, to be used by the NWDAF to access the third machine learning model from a model repository.

8. An apparatus comprising:
processor circuitry to:
process a request for configuration optimization information for an application;
cause a first machine learning model to generate a first intermediate result based at least in part on the request and collaborative analytics information;
access a second intermediate result generated using a second machine learning model at a network data and analytics function (NWDAF); and
cause a third machine learning model to predict a quality of experience (QoE) label metric associated with the application based at least in part on the first intermediate result and the second intermediate result; and
interface circuitry coupled to the processor circuitry to enable communication.

9. The apparatus of claim 8, wherein the collaborative analytics information comprises user equipment (UE) context information and application information.

10. The apparatus of claim 8, wherein the UE context information comprises UE mobility information or UE location information, and wherein the application information comprises an application data rate, a buffer capacity, or an available processing capacity.

11. The apparatus of claim 8, the processor circuitry further to:
select the first machine learning model from a model repository stored at an application function (AF) based on the QoE label metric;
select the second machine learning model from the model repository based on the QoE label metric; and
cause transmission to a NWDAF of the second machine learning model for predicting the second intermediate result.

12. The apparatus of claim 8, the processor circuitry further to:
adjust an application configuration based at least in part on the QoE label metric.

13. The apparatus of claim 8, the processor circuitry further to:
align an external identifier of a user equipment (UE) with an internal identifier of the UE, wherein the collaborative analytics information is based at least in part on the alignment.

14. The apparatus of claim 8, the processor circuitry further to:
provide an identifier of the third machine learning model to the NWDAF, to be used by the NWDAF to access the third machine learning model from a model repository.

15. One or more non-transitory, computer-readable media comprising a sequence of instructions that, when executed, cause processor circuitry to:
process a request for configuration optimization information for an application;
cause a first machine learning model to generate a first intermediate result based at least in part on the request and collaborative analytics information;
access a second intermediate result generated using a second machine learning model at a network data and analytics function (NWDAF); and
cause a third machine learning model to predict a quality of experience (QoE) label metric associated with the application based at least in part on the first intermediate result and the second intermediate result.

16. The one or more non-transitory, computer-readable media of claim 15,
wherein the collaborative analytics information comprises user equipment (UE) context information and application information.

17. The one or more non-transitory, computer-readable media of claim 16,
wherein the UE context information comprises UE mobility information or UE location information, and wherein the application information comprises an application data rate, a buffer capacity, or an available processing capacity.

18. The one or more non-transitory, computer-readable media of claim 15, wherein the sequence of instructions that, when executed, further cause processor circuitry to:
select the first machine learning model from a model repository stored at an application function (AF) based on the QoE label metric;
select the second machine learning model from the model repository based on the QoE label metric; and
cause transmission to a NWDAF of the second machine learning model for predicting the second intermediate result.

19. The one or more non-transitory, computer-readable media of claim 15, wherein the sequence of instructions that, when executed, further cause processor circuitry to:
adjust an application configuration based at least in part on the QoE label metric.

20. The one or more non-transitory, computer-readable media of claim 15, wherein the sequence of instructions that, when executed, further cause processor circuitry to:
align an external identifier of a user equipment (UE) with an internal identifier of the UE, wherein the collaborative analytics information is based at least in part on the alignment.
